(19) United States
(12) Patent Application Publication
(10) Pub. No.: US 2024/0416378 A1
(43) Pub. Date: Dec. 19, 2024

(54) A SPRAY BOOTH

(71) Applicant: DIAMOND CUT REFINISHING HOLDINGS LIMITED, Portsmouth (GB)

(72) Inventor: Steven John BARRETT, Hampshire (GB)

(21) Appl. No.: 18/727,100

(22) PCT Filed: Jan. 12, 2023
(86) PCT No.: PCT/IB2023/050290

§ 371 Date: Jul. 7, 2024

(30) Foreign Application Priority Data
Jan. 12, 2022 (GB) 2200302.4

(51) Int. Cl. B05B 16/20; B05B 12/00; B05B 12/02; B05B 12/08; B05B 13/02; B05B 16/40; B05B 16/80

(52) U.S. Cl. CPC B05B 16/20; B05B 12/004; B05B 12/02; B05B 12/084; B05B 13/0228; B05B 16/40; B05B 16/80

(57) ABSTRACT

A portable spray booth for coating an item such as a wheel with a sprayable material. An actuator is configured in use to support a spray gun which is in fluid communication with a first supply of the sprayable material. At least one laser is operative to illuminate a wheel with laser radiation. A detector detects reflected laser radiation from the wheel to derive a signal indicative of the profile of the wheel. A processor processes the signal to obtain a control signal which is output to the actuator and the spray gun to cause the first supply of sprayable material to be dispensed from the spray gun onto the wheel in a user defined manner and a detector senses an amount of sprayable material in each reusable paint pot or canister and generates a warning signal to reorder a paint pot or canister before all the sprayable is used.

### FIELD

The present invention relates to a spray booth, and in particular to a portable spray booth for coating an item, such as a wheel, with a sprayable material, such as a protective coating or paint. The present invention also relates to a method for coating an item, such as a wheel, with sprayable material.

### BACKGROUND

Automotive wheels are an important feature of vehicles, especially high end and luxury cars. Alloy wheel hubs for example not only contribute to the appearance of the vehicle but also to its value. Alloy wheels range in cost, colour and finish.

Sometimes wheels get scratched and require replacing in order to maintain the appearance of a car. For some types of wheel this can be expensive. However the inventor has developed a technique of repairing, refurbishing and recoating wheels, thereby improving their appearance and extending their life without compromising their integrity.

Some examples of automatic spraying and painting machines are described in the following publications.

### PRIOR ART

Chinese patent application number CN 110860442 (Baotou Shengtai Automobile Accessories Manufacturing Co limited) discloses a spraying machine for wheel coating. The spraying process is used for spraying of overdye wheels. A production line of the spraying process comprises a photoelectric sensor, a ground rail, wheel stations, a wheel wiping machine, a spray gun and a wheel positioning device.

Chinese utility model number CN 214052188U (Zhongmingggu Intelligent Robot Guangdong ltd) discloses a three-dimensional (3D) detection structure with a 3D camera scanner, a paint spray booth, a plurality of 3D camera units positioned in the paint spray booth and a personal computer (PC) connected to the 3D camera units.

The 3D camera units are used for scanning different parts of an object to be sprayed to form local scanning images. The PC is used for splicing the local scanning images to form an integral scanning image. Accurate 3D modelling of the to-be-sprayed object is achieved by means of the multiple 3D camera units.

Japanese patent application number JP 2001162211 (Kansai Paint Co ltd) describes a coating method by which a coating booth can be miniaturized and high coating ratio can be achieved by selecting the positions of coating guns and the number of guns are optimised for the section required to be coated.

United States patent application number US 2021/0252736 (Anthony Blackwelder) discloses a spray applicator system that applies liquid conditioning agent to at least one of a plurality of sides of an untreated board. The system comprises a plurality of spray nozzles each located within a chamber and oriented inwards. Liquid conditioning agent is brushed onto the sides of the untreated board when an untreated board enters the system.

When refurbishing and painting wheels, especially for premium and luxury vehicles, it is important that each wheel is of a consistent colour and finish. Otherwise the wheels on a vehicle do not match one another which can lead to a less aesthetic appearance and may even impact on the value of the vehicle.

However, a problem with existing wheel refurbishing and painting systems has been that when a particular container of paint depletes, there was a risk of an inconsistent colour of paint being applied by the spraying system. When this occurred it resulted in inconsistent colours on some of the wheels so that two or more wheels did not match which was undesirable.

The invention overcomes this by providing a system which optimises use of paint in a portable spray booth which reduces the size of a cavity in which the wheel is housed; controlling spray guns in order to optimise use of pain and consistency of finish and anticipates when paint levels are running low, thereby always ensuring sufficient pint is available.

### SUMMARY OF INVENTION

According to a first aspect of the present invention, there is provided a portable spray booth for coating an item, such as a wheel, with a sprayable material, the portable spray booth comprising:
an actuator configured in use to support at least one spray gun which is in fluid communication with a first supply of the sprayable material;
at least one laser which is operative to illuminate the item (wheel) with laser radiation;
a detector is operable to detect reflected laser radiation from the item (wheel) to derive a signal indicative of the profile of the item (wheel) for guiding the at least one spray gun;
a cleaner is operable to apply a cleaning material between application of a first and a second sprayable material to a surface of the item;
a processor is operable to process the signal from the detector to obtain a control signal which is output to the actuator and the at least one spray gun to cause a first sprayable material to be dispensed by the at least one spray gun from a first supply of sprayable material onto the item (wheel) in a user defined manner;
a storage unit for storing a plurality of reusable paint pots or canisters, each of which is selectable in dependence upon a signal from the processor to supply specific sprayable material to the at least one spray gun; and a detector which is operative to sense an amount of sprayable material in each reusable paint pot or canister and to generate a warning signal before all the sprayable material is used.

An advantage of the level detector is that because it senses the level of sprayable material in each reusable paint pot or canister and generates a warning signal before all the sprayable is used, a replacement pot or canister is always available in advance of a particular colour running out. This ensures that a consistent colour is always applied to each of the four (or five) wheels of a vehicle when they are painted or refurbished.

It is appreciated that the term sprayable material includes cleaning agents, coating materials, paints and protective coatings.

Optionally the processor monitors levels of sprayable material in each pot or canister so that a new paint job is only permitted to commence after a check has been made that there is a sufficient quantity of all sprayable materials for all the wheels. This safety device thereby checks the levels of sprayable material available and if there is insufficient amount of a particular sprayable material, such as specific colour paint, an alert is raised so that an operator is advised to replace a canister or pot prior to commencement of a new spray regime.

Ideally bespoke paint pot or canisters have unique labels, such as QR® codes or radio frequency identity (RFID) tags incorporated in them. As paint pots or canisters are reusable this reduces their environmental impact and ensures security of product.

This feature also ensures consistent quality and simplifies reordering of specific colours and types of sprayable materials. For example, when the processor senses that paint pots or canisters are ¾ empty, a message to re-order is transmitted so as to be certain that a replacement pot or canister is available to be fitted in prior.

Ideally an extractor fan is provided and which is operable in response to a command signal from the processor to extract fumes emitted from dispensing of the sprayable material.

In one embodiment the storage unit is in the form of a series of shelfs which stores at least ten pots or canisters of coloured paint which are used for painting the item.

In another embodiment the storage unit is in the form of a carousel which stores at least ten pots or canisters of coloured paint which are used for painting the item.

A specific colour may be selected from a menu or matched by way of an imaging means which automatically selects paints according to a reflected colour signal from the item. Once the colour has been identified the processor automatically dispenses the correct amount of paint(s), from one or more paint pots or canisters, so that the correctly selected colour is evenly coated on the item.

By laser profiling the item to be painted when it is placed in the spray booth a profile of it is created using software. The item is then rotated with respect to the at least one spray gun, and actuators control and direct the at least one spray gun so that the at least one spray gun moves precisely and coat the object with the first sprayable material.

The at least one spray gun is then automatically cleaned by the cleaner in readiness for application of a clear protective coating. Once this has been applied the at least one spray gun is one again cleaned.

Ideally the painted and coated item is then cured using for example infra-red (IR) heating lamps or an ultraviolet (UV) light.

Pots or canisters are preferably pressurised and dispense the correct amount of paint using a digitally controlled pneumatic supply system.

In some embodiments during operation extraction of fumes is controlled so as to exhaust paint fumes through a three-stage filter system. This ensures a safe working environment for operators.

In addition a memory may be provided to record specific customer details and information relating to each specific task, such as date of a refurbishment and respray, number of wheels and their specific details and condition, colour and type of treatment finish, profile of existing wheels (so as to allow any damage or changes to be identified later when comparing with subsequent images), name and address of a customer and vehicle registration details. All this data is able to be accessed from a database and provided to a customer on request.

According to a second aspect of the present invention, there is provided a method of coating an item (wheel) with a sprayable material using a portable spray booth as herein described, the method comprising the steps of:
mounting the item (wheel) within the spray booth;
illuminating the item (wheel) with laser radiation from at least one laser;
operating a detector to detect reflected laser radiation from the item (wheel) to derive a signal indicative of the profile of the wheel for guiding the at least one spray gun;
supplying a sprayable material to be dispensed from at least one spray gun;
processing the signal using a processor to obtain a control signal and outputting the control signal to an actuator to cause the at least one spray gun, supported on the actuator, to cause a first supply of sprayable material to be dispensed from the at least one spray gun onto the item (wheel) in a user defined manner;
applying a cleaning material between application of a first and a second sprayable material to a surface of the item;
storing in a storage unit a plurality of reusable paint pots or canisters, each of which is selectable in dependence upon a signal from the processor to supply a specific sprayable material to the at least one spray gun; and
detecting an amount of sprayable material in each reusable paint pot or canister and generating a warning signal before all the sprayable is used.

The portable spray booth preferably comprises one or more side portions, optionally together with a base and/or upper portion between which the side portion(s) extend(s), defining a cavity extending therebetween. The cavity is preferably shaped and dimensioned to receive a wheel for coating with a sprayable material.

In one embodiment, the portable spray booth may comprise a wheel support for mounting a wheel thereon. The wheel support may be configured to present the surface(s) intended to be coated towards the at least one spray gun.

Preferably, the wheel support has a rotatable support which is configured to enable the wheel to be rotated relative to the at least one spray gun. For example, the wheel support may include a motor configured in use to rotate the wheel with respect to the at least one spray gun. The wheel may be rotated, with respect to the booth and/or the or each spray gun, before and/or during and/or after dispensing of sprayable material.

In one embodiment, the wheel support, and wheel, are rotated, with respect to the booth and/or the or each spray gun during dispensing of sprayable material, such as paint, which is ideally subsequent to coating of the wheel with a sprayable material, such a coating. The wheel support may be rotatable at any suitable speed of rotation relative to the booth and/or spray gun(s). For example, the wheel support may be rotatable at a speed of at least 1 RPM, preferably at least 2 RPM, for example at 5 RPM.

In one embodiment, one or more side portion(s) and/or upper portion(s), preferably one or more side portions, comprises a door moveable between a first closed position in which access to the cavity is prevented, and a second open position providing access to the cavity.

The door may be slidable relative to the side portion or upper portion. The door may be connected by one or more hinges to a side portion or upper portion.

The door is preferably configured such that in the first closed position the door may be locked in order to prevent unintentional access to the cavity.

The, or each, lockable door may comprise an automatic lock configured in use to release the lockable door after a predetermined time period and/or after dispensing of the sprayable material has stopped.

The portable spray booth may further comprise an automatic lock configured in use to release after a predetermined time period.

The automatic lock or lockable door may be locked after mounting of the wheel within the booth, for example within the cavity of the booth, and prior to dispensing of sprayable material. Preferably, the automatic lock or lockable door may be locked after mounting of the wheel within the booth and before illuminating the wheel with laser radiation and/or before detecting reflected laser radiation.

The extractor fan is ideally operable in response to a command signal from the processor to extract fumes emitted from dispensing of the sprayable material. For example, the extractor fan may be operable to extract fumes, from within for example the cavity of the booth, during and/or after dispensing of sprayable material onto the wheel. Preferably, the extractor fan is operable to extract fumes after dispensing of a sprayable material onto a wheel.

The extractor fan may be operable to extract fumes for a predetermined time period during and/or after dispensing of sprayable material onto the wheel.

The booth may comprise at least one removable filter configured in use to be in fluid connection with the extractor fan.

In one embodiment, the portable spray booth has at least one infra-red (IR) lamp configured in use to dry surface(s) of the wheel after coating with sprayable material. The infra-red (IR) lamp is preferably automatically controllable and able to be oriented towards the wheel and/or wheel mount within the booth.

The infra-red (IR) lamp may be operable to dry surface(s) of the wheel after dispensing of sprayable material onto the wheel. The infra-red (IR) lamp may be operable for a predetermined time period, for example for at least 5 minutes, preferably for 10 minutes.

The portable spray booth preferably further comprises one or more further supplies of sprayable material, for example a second supply of the sprayable material via a suitable dual supply channel. The one or more further supplies of sprayable material may each be in communication with a further spray gun. It is however to be understood that the one or more further supplies of sprayable material may be configured to be in fluid communication with the same spray gun which is supplied with the first sprayable material.

In one embodiment, the method comprising output of one or more further control signals to one or more actuators, such as a hydraulic actuator or robot or a combination other to cause one or more spray guns supported on the corresponding actuators to cause a second or further supply of sprayable material to be dispensed from corresponding spray guns onto the wheel in a user defined manner.

In one embodiment, the portable spray booth further comprises a timer configured in use to oversee a predetermined sprayable material spraying regime. The timer may for example be configured in use to control supply of the first and/or further (for example second) sprayable materials to the at least one spray gun. The timer may for example be configured to delay supply, by for example a predetermined time period, of the first and/or further sprayable materials.

A cleaner may be provided in use to apply a cleaning material between application of the first and/or further (for example second) sprayable materials. The cleaner may be in communication with one or more, for example each, spray gun.

Ideally the at least one spray gun is self-cleaning and ideally has a dedicated cleaning apparatus which automatically empties and purges a spray head or nozzle between spray sessions so that paint does not clog or coagulate in the spray head or nozzle of the at least one spray gun.

The sprayable material(s) are preferably one or more of: paint and/or lacquer. The sprayable material may be coloured with dye or may be a colourless, clear material.

The booth may comprise a plurality of coloured paints which are configured to be mixed in varying ratios to provide a wide range of colour options for the paint.

The method may further comprise the user matching the colour of the wheel and/or selecting predetermined paint colour from multiple colour options. The user may select a predetermined paint colour using a control panel.

The wheel is preferably a wheel of a vehicle, for example a car wheel, van wheel, lorry wheel, motorbike wheel, moped wheel.

The present invention provides a booth and a method for coating a wheel which allows for the particular size and geometry of the surface of the wheel to be taken into account during application of the coating(s). The booth and method of the present invention can therefore be used to accurately coat a wide range of wheels and to provide a smooth, flawless finish.

According to another aspect of the invention there is provided a system which includes the portable spray booth and a radio frequency (RF) reader which is operative to read RF identity (RFID) tags applied to, or preferably formed integrally with, paint pots or canisters.

An advantage of the system is that the RF reader identifies a particular colour or type of pain and a volume monitor measures and records the amount of paint that has been used from each individual paint pot or canister. The processor receives signals from the RFID reader and the volume monitor and a record of the amount used is updated at each use. The processor is operative to detect when a specified amount of paint has been used or when the level of paint drops to a specified volume in the paint pot or canister. When this occurs an alarm may be triggered or preferably a message sent to a paint supplier so that that a replacement paint pot or canister is ordered automatically and delivered in advance of the paint running out.

An advantage is that the spray booth operator never runs out of paint so that a specific refurbishing or paint job is always able to be completed and avoids the need for storing excess pant pots and so there is less requirement to store so much expensive stock of paint. An advantage to the supplier is that their supply chain is managed and monitored as messages can be received from several spray booths automatically and stock control and bulk ordering are both optimised.

The storage unit preferably stores more than five paint pots or canisters, more preferably more than ten paint pots or canisters, and most preferably more than fifteen paint pots or canisters are stored and presented to an inlet to the at least one spray gun in order to supply the sprayable material which they contain.

Embodiments of the present invention will now be described in more detail with reference to the Figures in which:

### BRIEF DESCRIPTION OF FIGURES

FIG. 1A is a schematic illustration of a perspective front view of the portable spray booth according to one embodiment of the present invention;

FIG. 1B is a schematic illustration of a perspective front view of a base section of the portable spray booth according to one embodiment of the present invention;

FIG. 1C is a schematic illustration of a perspective rear view of a base section of the portable spray booth according to one embodiment of the present invention;

FIG. 1D is a schematic illustration of a perspective front view of an upper section of the portable spray booth according to one embodiment of the present invention;

FIG. 1E is a schematic illustration of a perspective front view of an upper section of the portable spray booth according to one embodiment of the present invention;

FIG. 1F is a schematic illustration of a perspective front view of an upper section of the portable spray booth according to one embodiment of the present invention;

FIG. 1G is a schematic illustration of a perspective rear view of an upper section of the portable spray booth according to one embodiment of the present invention;

FIG. 1H is a schematic illustration of a further perspective front view of the portable spray booth according to one embodiment of the present invention; and

FIG. 2 is a flowchart of one example of a method of coating a wheel with a portable spray booth according to one embodiment of the invention.

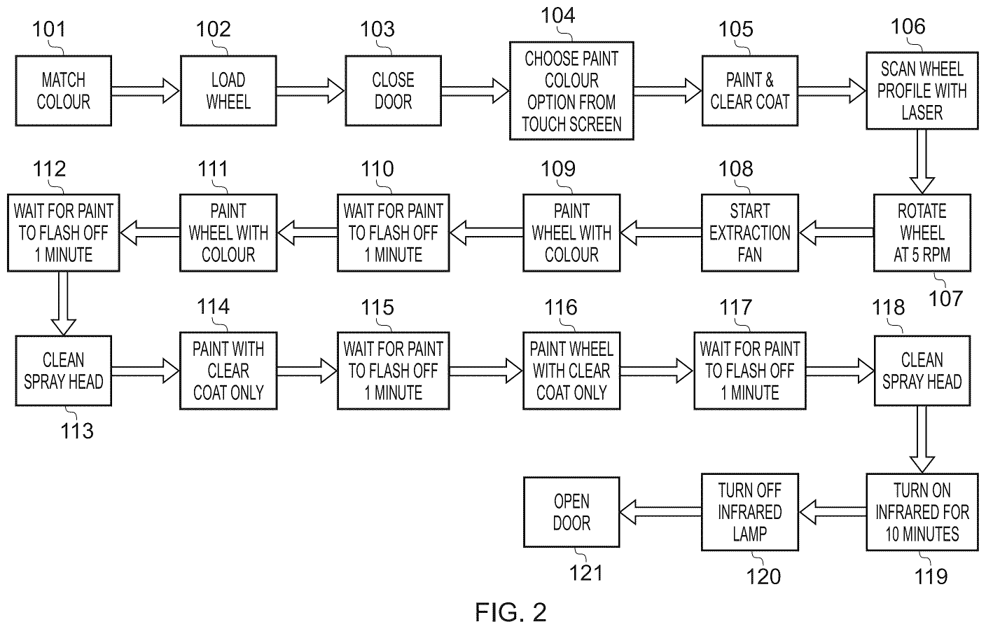

### DETAILED DESCRIPTION OF PREFERRED EMBODIMENTS

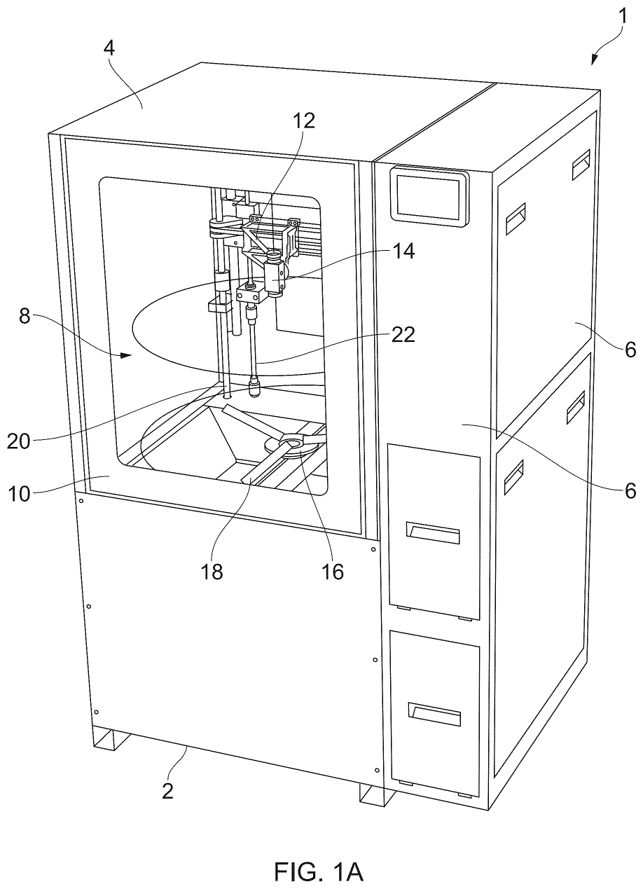

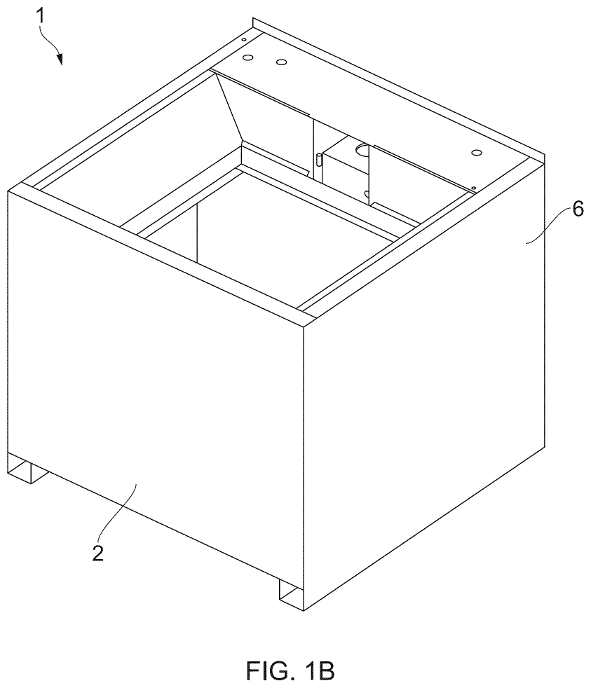

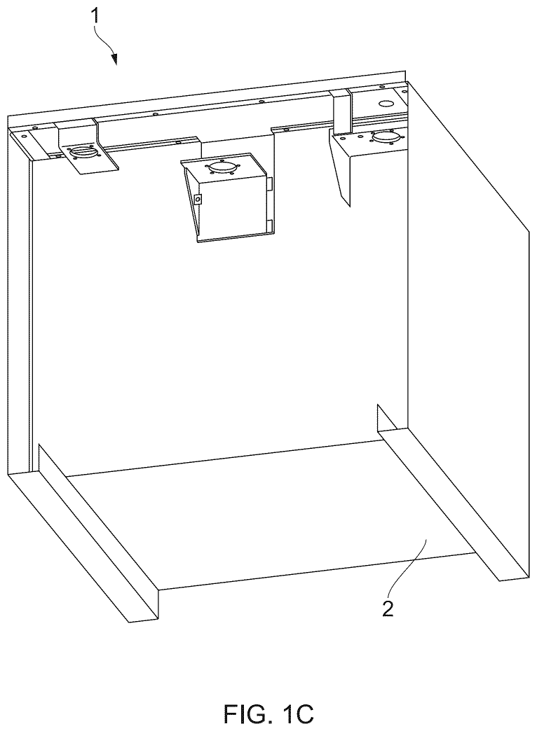

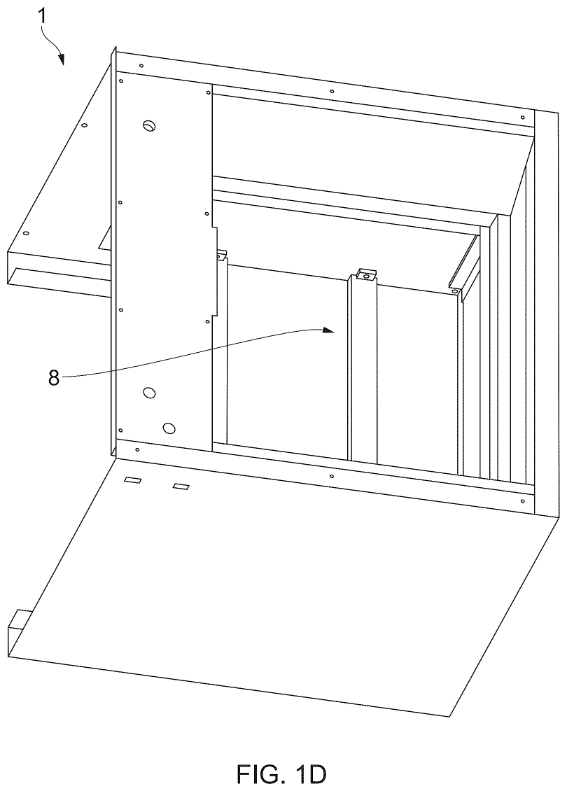

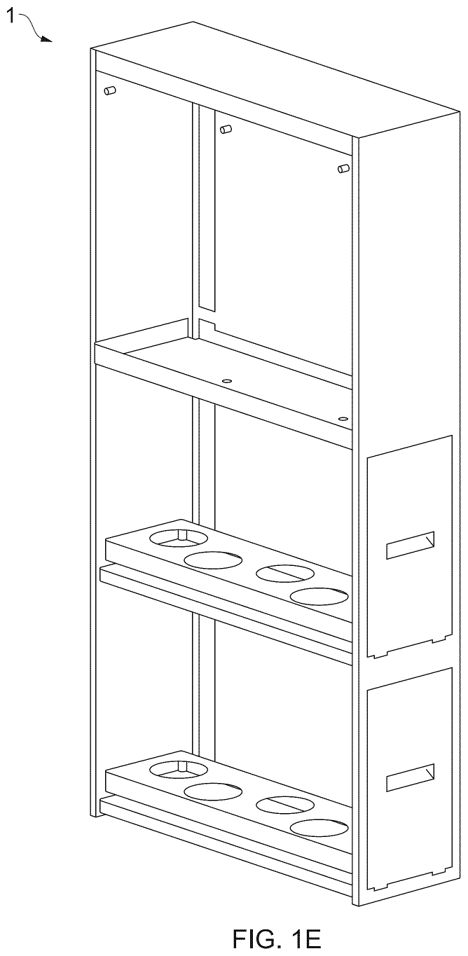

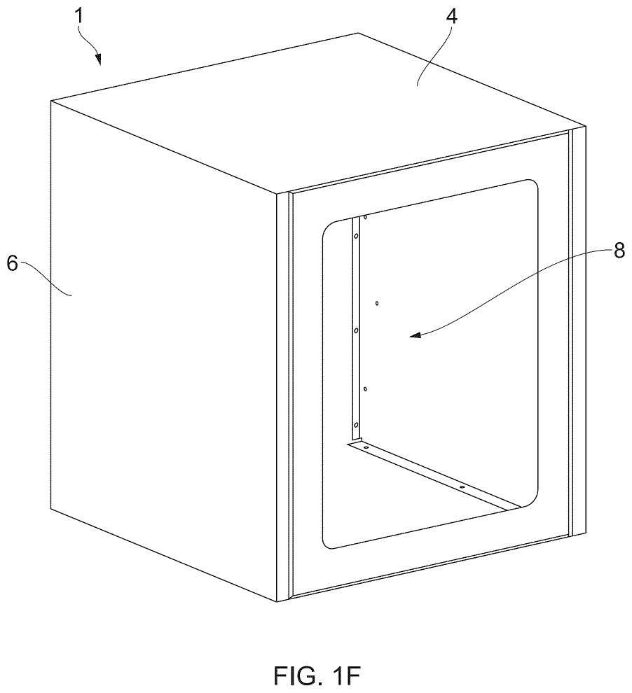

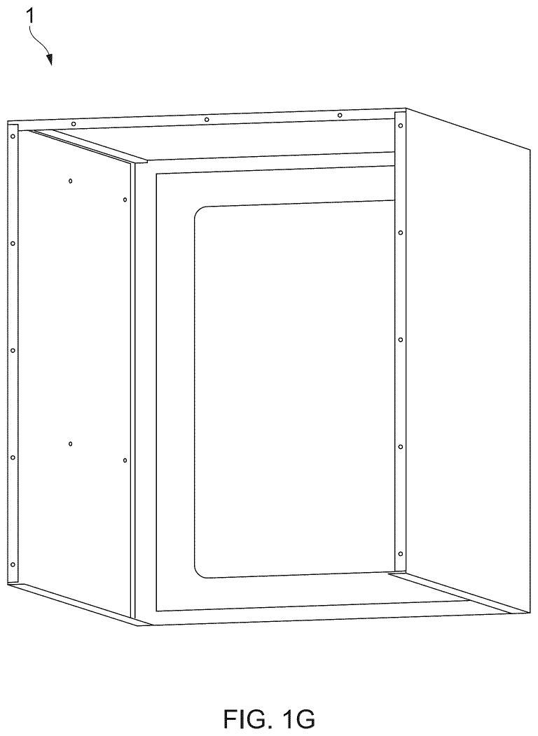

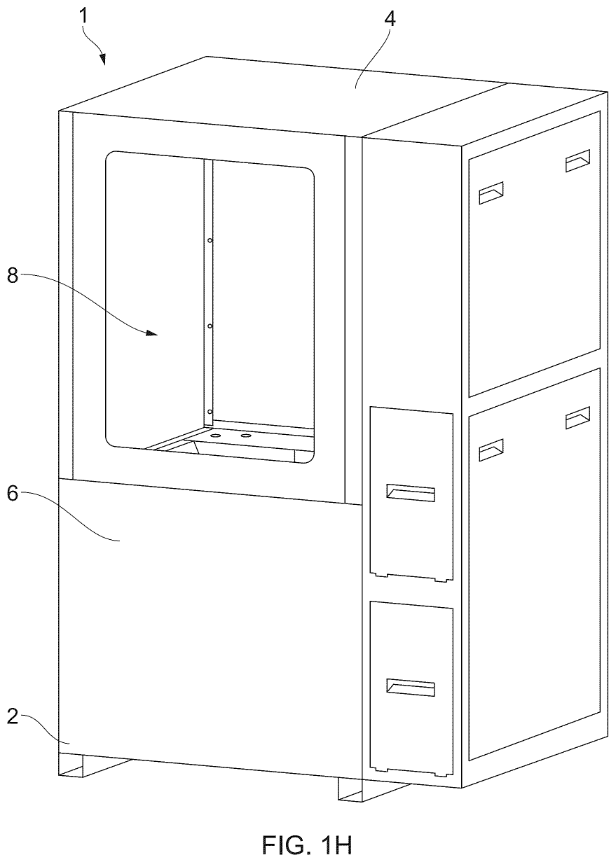

With reference to FIGS. 1A-H, the portable spray booth 1 for coating a wheel with a sprayable material comprises a base portion 2 configured to be supported on a contact surface, an opposed upper portion 4 and four side portions 6 extending therebetween. The portable spray booth 1 is substantially cuboid in shape. It is however to be understood that the booth may have any suitable shape and dimensions, and may have any suitable number of side portions, and is not limited to being cuboid in shape. It is also to be understood that the booth may, in some embodiments, not include an upper portion and/or base portion.

A cavity 8 is defined between the base portion 2, upper portion 4 and the four side portions 6. The cavity 8 is shaped and dimensioned to receive an item, such as a wheel, (not shown) therein.

The booth 1 has a door 10 positioned on a front side portion 6. The door 10 is moveable from a first closed position (as shown in FIG. 1) preventing access to the cavity, and a second open position enabling access to the cavity.

The door 10 is lockable and comprises an automatic lock configured in use to release the lockable door 10 after a predetermined time period and/or after dispensing of sprayable material has stopped.

An actuator 12 is positioned within the cavity 8 towards the upper portion 4. The actuator 12 supports a spray gun 14 which is in fluid communication with a first supply of spray material (not shown).

A wheel support 16, in the form of three spaced apart radially extending arms 18, is located within the cavity 8 towards the base portion 2. The wheel support 16 is configured to support a wheel thereon. In the illustrated embodiment, the wheel support 16 is configured to support a wheel such that the wheel defines a plane which extends perpendicular to the direction of projection of sprayable material from the spray gun 14 and/or an axis formed between the centre of the wheel and the nozzle of the spray gun 14. It is however to be understood that the plane of the wheel may extend at any suitable angle relative to the spray gun 14. The wheel support 16 includes a motor configured in use to rotate the radially extending arms to rotate the wheel with respect to the spray gun 14.

The booth 1 further comprises a laser 20 operative to illuminate a wheel with laser radiation. The laser 20 is located within the cavity 8 towards the upper portion 4. The booth 1 further comprises a detector 22 located within the cavity 8 towards the upper portion 4. The detector 22 is configured in use to detect reflected laser radiation from the wheel to derive a signal indicative of the profile of the wheel.

The spray booth 1 further comprises a processor (not shown) configured in use to process the signal from the detector 22 to obtain a control signal which is output to the actuator 12 and the spray gun 14 to cause the first supply of sprayable material to be dispensed from the spray gun 14 onto the wheel in a user defined manner. An example of how the

The portable spray booth further comprises a timer (not shown) configured in use to oversee a predetermined sprayable material spraying regime. The timer is configured in use to control supply of the first and/or further (for example second) sprayable materials to the spray gun. The timer is also configured to delay supply, by for example a predetermined time period, of the first and/or further sprayable materials.

The booth further comprises a cleaner to apply a cleaning material between application of the first and/or further (for example second) sprayable materials. The cleaner is in communication with the spray gun.

With reference to FIGS. 1A-G and 2, in use, a user matches the colour of the wheel to a paint chart (101). The door 10 of the booth 1 is opened into the second open position, and a wheel is mounted (102) on the radially extending arms 18 of the wheel support 16. The door 10 is then moved to the first open position (FIG. 1) and automatically locked (103).

The user chooses the desired paint colour option using a control panel (for example a touch screen) (104). The required paint and the required clear coating material is selected (105).

The wheel is illuminated with laser radiation from laser 20. Reflected laser radiation from the wheel is detected (106) by detector 22.

The motor rotates the wheel support 16 such that the wheel rotates at 5 RPM relative to the booth 1 and spray gun 14 (107).

The extraction fan is operated to extract fumes from the cavity 8 (108).

The processor processes the signal from the detector 22 to obtain a control signal which is then outputted to the actuator 12 to cause the spray gun 14 to cause a first supply of sprayable material, in this case the selected paint, to be dispensed from the spray gun 14 onto the wheel in a user defined manner (109).

The spray gun 14 continues to dispense sprayable material until a complete, smooth coating of the sprayable material is provided on the surface of the wheel.

The processor outputs a control signal to the actuator 12 to cease first supply of sprayable material after a first predetermined time period (110). A timer is operable to provide a first predetermined setting time period during which no further coatings of sprayable material are applied to the wheel. After the first predetermined setting time period, which is typically about 1 minute, the processor outputs a further control signal to the actuator 12 to cause the spray gun 14 to cause a further first supply of sprayable material, in this case the selected paint, to be dispensed from the spray gun 14 onto the wheel in a user defined manner (111).

The processor outputs a control signal to the actuator 12 to cease first supply of sprayable material after a second predetermined time period (112).

The timer is operable to provide a second predetermined setting time period during which no further coatings of sprayable material are applied to the wheel. After the second predetermined setting time period, which is typically about 1 minute, the processor outputs a further control signal to the cleaner (not shown) to cause the cleaner to clean the spray head of the spray gun 14 (113).

After the cleaner has completed cleaning of the spray head of the spray gun 14, the processor outputs a control signal to the actuator 12 to cause the spray gun 14 to cause a second supply of sprayable material, in this case the selected clear coating, to be dispensed from the spray gun 14 onto the wheel in a user defined manner (114).

The processor then outputs a control signal to the actuator 12 to cease second supply of sprayable material after a first predetermined time period (115). A timer is operable to provide a first predetermined setting time period during which no further coatings of sprayable material are applied to the wheel. After the first predetermined setting time period, which is typically about 1 minute, the processor outputs a further control signal to the actuator 12 to cause the spray gun 14 to cause a further second supply of sprayable material, in this case the selected clear coating, to be dispensed from the spray gun 14 onto the wheel in a user defined manner (116).

The processor outputs a control signal to the actuator 12 to cease second supply of sprayable material after a second predetermined time period (117).

The timer is operable to provide a second predetermined setting time period during which no further coatings of sprayable material are applied to the wheel. After the second predetermined setting time period, which is typically about 1 minute, the processor outputs a further control signal to the cleaner (not shown) to cause the cleaner to clean the spray head of the spray gun 14 (118).

The processor outputs a control signal to an infra-red (IR) lamp (not shown) to operate the IR lamp for a predetermined time period (119), typically about 5 minutes, to dry the coatings on the wheel. On completion of the predetermined time period, the IR lamp is turned off (120), and the door of the booth 1 is opened (121) and the painted, coated wheel is removed.

The extraction fan is also provided and removes fumes from within the cavity 8. A time lock is ideally provided which prevents the door 10 from being opened until after fumes have been removed.

It is to be noted that the item placed within the booth may be a wheel or may be any other suitable item for coating with sprayable material.

The item may be coated with any combination of sprayable materials, in any particular order, and is not limited to being first coated with paint and subsequently coated with clear coatings.

The item may be coated with any suitable number of coatings of each sprayable material and is not limited to being coated with two coatings of paint and two coatings of clear coating.

Ideally bespoke paint pot or canisters have radio frequency identity (RFID) tags incorporated in them and the paint pot or canister are reusable which reduces their environmental impact, ensures security of product quality and simplifies reordering, for example when the processor senses they are ¾ empty and re-order.

The invention has been described by way of examples only and variation may be made to the embodiments described, without departing from the scope of protection, as defined by the claims. For example it will be appreciated that one or more different spray guns may be used to dispense the same or different paints or sprayable materials.

Therefore, for example, although the booth has been described as portable it is appreciated that the booth may be free-standing for permanent use. Likewise although specific reference has been made to a wheel it will be appreciated that the spray booth may be used to coat other items.

1-26. (canceled)

27. A portable spray booth for coating a wheel with a sprayable material, the portable spray booth comprising:
an actuator configured in use to support a spray gun which is in fluid communication with a first supply of the sprayable material;
at least one laser operative to illuminate a wheel with laser radiation;
a detector configured in use to detect reflected laser radiation from the wheel to derive a signal indicative of the profile of the wheel; and
a processor configured in use to process the signal to obtain a control signal which is output to the actuator and the spray gun to cause the first supply of sprayable material to be dispensed from the spray gun onto the wheel in a user defined manner.

28. A portable spray booth according to claim 27, further comprising a wheel support for mounting a wheel thereon, in which the wheel support includes a motor configured in use to rotate the wheel with respect to the spray gun.

29. A portable spray booth according to claim 27, further comprising an extractor fan which is operable in response to a command signal from the processor to extract fumes emitted from dispensing of the sprayable material.

30. A portable spray booth according to claim 29, further comprising at least one removable filter configured in use to be in fluid connection with the extractor fan.

31. A portable spray booth according to claim 27, further comprising a lockable door.

32. A portable spray booth according to claim 31, wherein the lockable door comprises an automatic lock configured in use to release the lockable door after a predetermined time period and/or after dispensing of the sprayable material has stopped.

33. A portable spray booth according to claim 27, further comprising an automatic lock configured in use to release after a predetermined time period.

34. A portable spray booth according to claim 27, further comprising an infra-red (IR) lamp.

35. A portable spray booth according to claim 27, further comprising a second supply of the sprayable material.

36. A portable spray booth according to claim 27, further comprising a timer configured in use to oversee a predetermined sprayable material spraying regime, in which the timer is configured in use to control supply of the first and/or second sprayable materials to the spray gun.

37. A portable spray booth according to claim 36, further comprising a cleaner configured in use to apply a cleaning material between application of the first and/or second sprayable materials.

38. A method of coating a wheel with a sprayable material using a portable spray booth as claimed in claim 27, the method comprising:
mounting a wheel within the spray booth;
illuminating the wheel with laser radiation from at least one laser;
detecting reflected laser radiation from the wheel using a detector to derive a signal indicative of the profile of the wheel;
processing the signal using a processor to obtain a control signal, output the control signal to an actuator to cause a spray gun supported on the actuator to cause a first supply of sprayable material to be dispensed from the spray gun onto the wheel in a user defined manner.

39. A method as claimed in claim 38, further comprising rotating the wheel with respect to the spray gun.

40. A method as claimed in claim 38, comprising extracting fumes emitted during dispensing of sprayable material using an extractor fan in response to a command signal from the processor.

41. A method as claimed in claim 38, comprising locking a lockable door of the booth after mounting the wheel and prior to dispensing of sprayable material.

42. A method as claimed in claim 38, comprising drying the coated wheel using an infra-red (IR) lamp.

43. A method as claimed in claim 38, comprising output a further control signal to the actuator to cause a spray gun supported on the actuator to cause a second supply of sprayable material to be dispensed from the spray gun onto the wheel in a user defined manner.

44. A method as claimed in claim 43, comprising operating a timer to oversee a predetermined sprayable material spraying regime, in which the timer is configured to control supply of the first and/or second sprayable materials to the spray gun.

45. A method as claimed in claim 38, comprising applying a cleaning material from a cleaner between application of the first and/or second sprayable materials.

46. A system includes the portable spray booth according to claim 27 includes a radio frequency (RF) reader which is operative to read an RF identity (RFID) tag applied to, or preferably formed integrally with, paint pots or canisters.

47. A system according to claim 46 includes a volume monitor which measures and records the amount of paint that has been used from a paint pot or canister.

48. A system according to claim 47 wherein the processor receives signals from the RFID reader and the volume monitor and records an amount of sprayable, material that has been used and updates a memory.

49. A system according to claim 48 wherein the processor is operative to detect when a specified amount of paint has been used, or when the level of paint drops to a specified volume in the paint pot or canister, and triggers an alarm and/or sends a message to a paint supplier.

50. A system according to claim 46 includes a carousel which stores a plurality of paint pots or canisters, preferably more than five paint pots or canisters, more preferably more than ten paint pots or canisters, and most preferably more than fifteen paint pots or canisters are stored so that in use each one is presented to an inlet to the spray gun in order to supply the sprayable material which they contain.

51. A system according to claim 46 wherein paint pot or canisters have RFID tags incorporated.
